(19) United States
(12) Patent Application Publication
(10) Pub. No.: US 2026/0274295 A1
(43) Pub. Date: Sep. 17, 2026

(54) SYSTEM AND/OR METHOD FOR AUTONOMOUS DETECTION OF EMERGENGY VEHICLES

(71) Applicant: May Mobility, Inc., Ann Arbor, MI (US)

(72) Inventors: Varshith Solipuram, Ann Arbor, MI (US); Shasa Antao, Ann Arbor, MI (US); Fiona Hua, Ann Arbor, MI (US); Jacob Crossman, Ann Arbor, MI (US); Edwin B. Olson, Ann Arbor, MI (US)

(21) Appl. No.: 19/564,754

(22) Filed: Mar. 12, 2026

Related U.S. Application Data
(60) Provisional application No. 63/770,639, filed on Mar. 12, 2025.

(51) Int. Cl. B60W 60/00; G10L 19/02

(52) U.S. Cl. CPC B60W 60/001; G10L 19/02; B60W 2420/54; B60W 2556/45

(57) ABSTRACT

A method and system for operating an autonomous vehicle, comprising collecting perceptual measurements and audio measurements from sensors arranged at different positions on the autonomous vehicle; determining a world representation comprising detections of world agents from the perceptual measurements; determining auditory flags from the audio measurements, each comprising a direction estimate of an audio-emitting world agent; tracking world agent tracks by associating auditory flags with world agent detections; determining vehicle controls based on the tracks; and operating the vehicle accordingly. The auditory flags can be generated by a trained convolutional neural network processing log-mel spectrograms of the audio measurements, with siren signal isolation via frequency masking enabling direction-of-arrival estimation through time-difference-of-arrival computation across microphone pairs.

### CROSS REFERENCE TO RELATED APPLICATIONS

This application claims priority benefit to U.S. Provisional Application No. 63/770,639, filed on MAR. 12, 2025 which is related to U.S. Application Serial No. 17/941,225, filed SEP. 09, 2022, U.S. Application Serial No. 17/949,921, filed SEP. 21, 2022, U.S. Provisional Application No. 63/574,710, filed APR. 04, 2024, U.S. Provisional Application No. 63/570,079, filed MAR. 26, 2024, U.S. Application Serial No. 19/091,533, filed MAR. 26, 2025, and U.S. Application Serial No.19/092,856, filed MAR. 27, 2025, U.S. Provisional Application No. 63/570,613, filed MAR. 27, 2024 and U.S. Provisional Application No. 63/574,684, filed APR. 04, 2024, each of which is incorporated herein in its entirety by this reference.

### TECHNICAL FIELD

This invention relates generally to the transportation field, and more specifically to a new and useful emergency vehicle detection system and/or method in the transportation field.

### BRIEF DESCRIPTION OF THE FIGURES

FIG. 1 is a schematic representation of an embodiment of the method.

FIG. 2 is a schematic representation of an embodiment of the system.

FIG. 3 is an illustrative example of an embodiment of the method.

FIG. 4 is an illustrative example of an emobdiment of environmental interpretation by the vehicle.

FIGS. 5A-5B are illustrative examples of embodiments of audio sensors on the autonomous vehicle.

FIGS. 6A-6C are illustrative examples of embodiments of tracked auditory flags and world agent tracks.

### DETAILED DESCRIPTION

### Overview

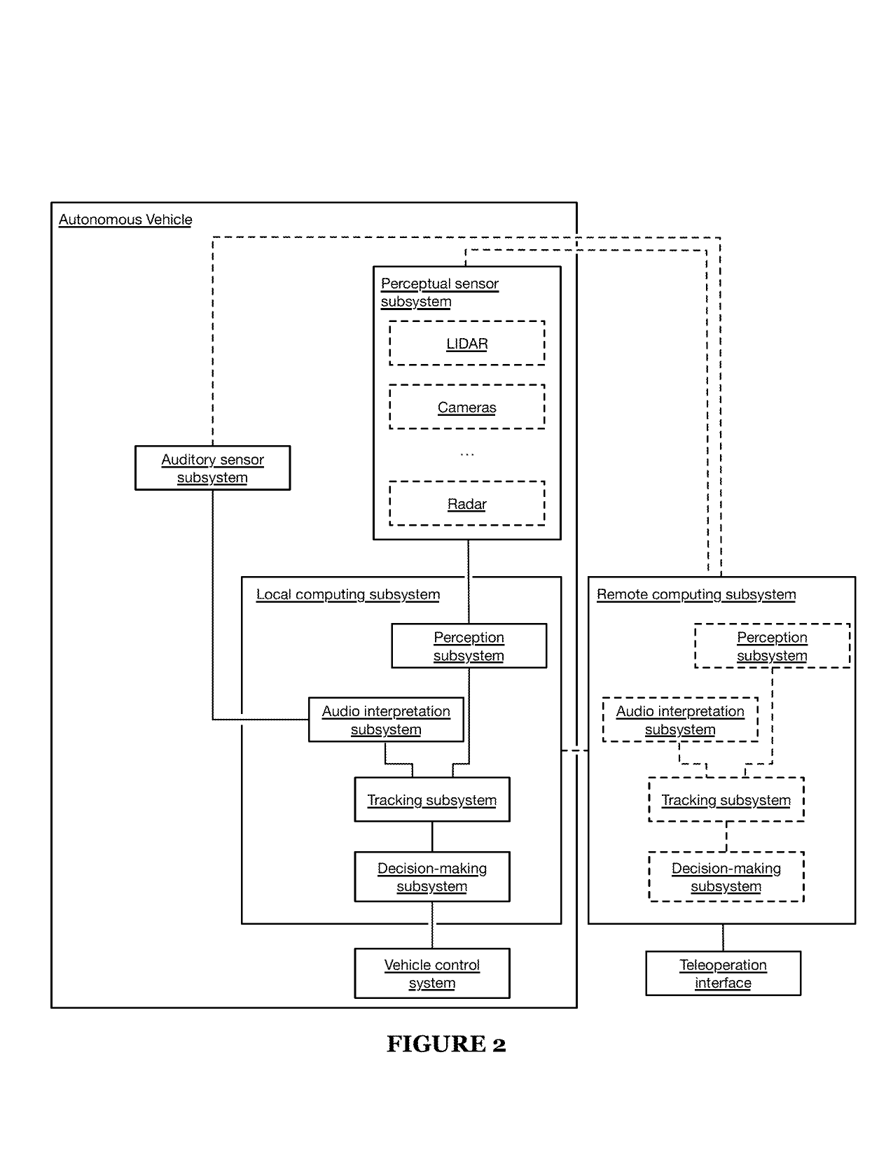

The system 100 can include: a sensor suite, a computing system, and a vehicle control system. The system can optionally include a communication system, a remote computing system (e.g., remote tele-op system and/or redundant, remote computing system), and/or any other suitable components. However, the system 100 can additionally or alternatively include any other suitable set of components. The system functions to perform decision-making for an autonomous vehicle based on perceptual and audio measurements capturing information about an audio-emitting world agent (e.g., an example is shown in FIG. 2).

The system can include or be used with an autonomous vehicle. The autonomous vehicle is preferably a car, truck, or other road vehicle, but can alternatively be a non-road vehicle (e.g., aerial drone, etc.), and/or any other suitable vehicle. For example, the system can be configured for: fully autonomous driving, partially autonomous driving, manual driving, teleoperation, and/or any other driving configuration(s). The system is preferably configured for level 5 or level 4 autonomy, but can alternatively be configured for less than level 4 autonomy, and/or can be otherwise configured.

Additionally, the components of the system are preferably integrated onboard an autonomous vehicle, but can additionally or alternatively have system components remote from the autonomous vehicle (e.g., in a remote cloud, in another vehicle, etc.). For example, the system 100 can be integrated with any one or more of the vehicle architectures described in U.S. Application Serial No. 16/514,624, filed 17-JUL-2019, U.S. Application Serial No. 17/550,461, filed 14-DEC-2021, and/or U.S. Application Serial No. 17/826,655, filed 27-MAY-2022, each of which is incorporated herein in its entirety by this reference.

The term “audio-emitting world agent” can refer to any world agent which emits audible audio signals, including ambulances, fire trucks, police cars, aerial drones, school buses, transit buses, freight trains, passenger trains, and/or any other audio-emitting agents. The term can additionally and/or alternatively refer to world agents engaging in an audio-producing behavior (e.g., operating under sirens, a roaring engine, a tire screech, a honk, etc.). However, the term(s) audio-emitting world agent and/or emergency vehicle(s) can be otherwise suitably used or referenced herein, and/or the term emergency vehicle may be interchangeably referenced with audio-emitting world agent herein in some context (e.g., when operating under sirens).

The term “substantially” as utilized herein can mean: exactly, approximately, within a predetermined threshold or tolerance, and/or have any other suitable meaning.

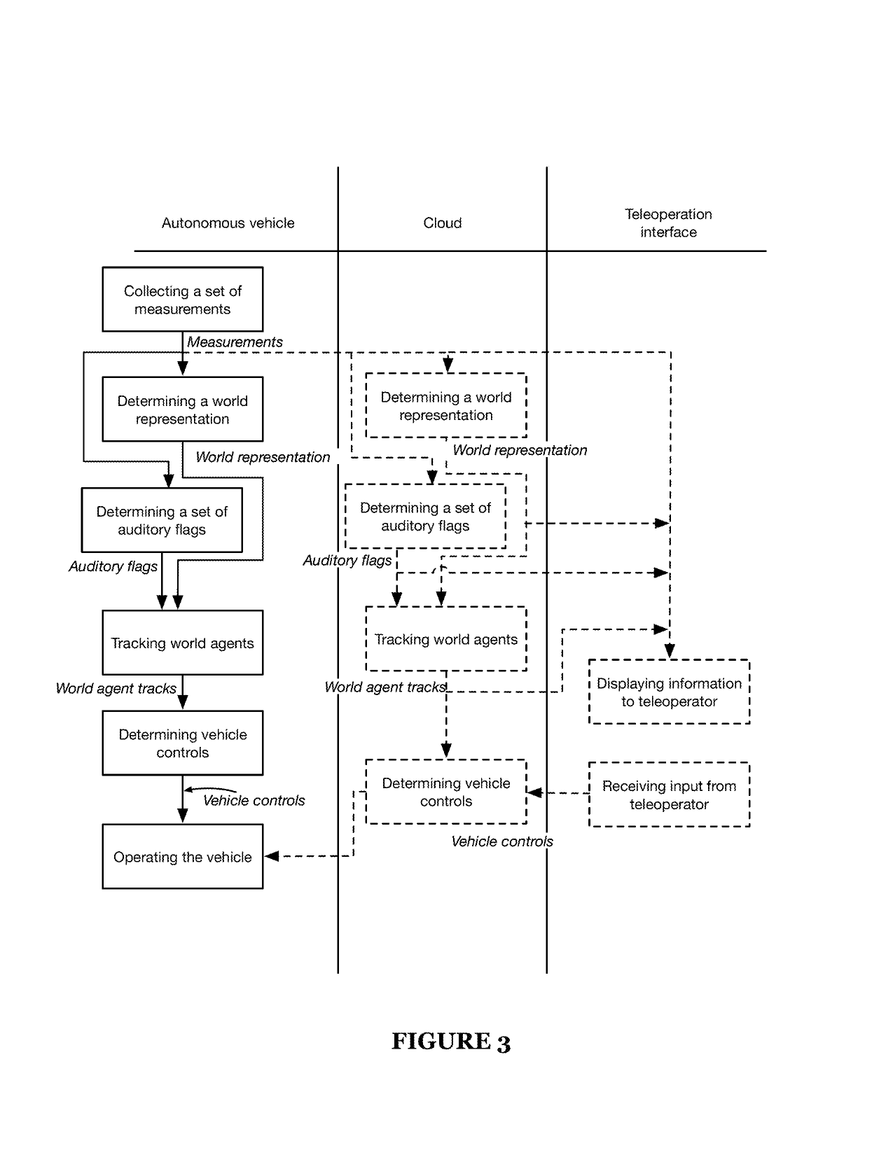

In an illustrative example, embodiments of the method can facilitate high-quality perception on an autonomous vehicle by fusing tracked auditory flags determined from audio measurements and world agent tracks determined from perceptual measurements (e.g., example shown in FIG. 3). In some embodiments, a set of perception and audio sensors arranged at different positions on the autonomous vehicle can capture audio measurements and perceptual measurements. A world representation can be determined from the perceptual measurements by sensor fusion, and a set of auditory flags can be determined from the audio measurements. The auditory flags can be tracked over time and used to improve both perception and tracking of audio sources (e.g., emergency vehicles emitting sound, etc.) based on the world representation. Based on the world agent tracks determined from the world representation and auditory flags, a local or remote computing system can determine a set of autonomous vehicle controls based on the tracked world agents, and the autonomous vehicle can be operated according to the autonomous vehicle controls.

### Benefits

Variations of the technology can afford several benefits and/or advantages.

First, embodiments of the technology can improve the reaction time of an autonomous vehicle to the approach of an emergency vehicle. By implementing tracked auditory flags, the system can detect emergency vehicles even when visual line-of-sight is obstructed (e.g., by buildings, other vehicles, or terrain features). This capability can enhance the autonomous vehicle’s situational awareness beyond traditional visual-based detection methods. For example, the system can initiate appropriate response behaviors (e.g., pulling over, yielding) before visual confirmation of the emergency vehicle, which can reduce response latency and improve overall traffic safety. Additionally, the integration of auditory flags can serve to reinforce low-confidence visual detections within the virtual world representation, thereby increasing detection reliability.

Second, embodiments of the technology can improve the quality of tracked information determined from audio measurements. The system’s ability to track auditory flags over time can enable detection and monitoring of emergency vehicles with intermittent siren patterns, which can be challenging for conventional detection systems. Through continuous tracking of audio-emitting world agents, the system can generate comprehensive trajectory estimates including direction, distance, and movement patterns of emergency vehicles. In embodiments where source direction estimation is implemented, the technology can differentiate and track multiple emergency vehicles based on distinct auditory signatures (e.g., different siren patterns, frequency characteristics). This capability can be particularly valuable in complex emergency scenarios involving multiple response vehicles, where accurate identification and tracking of individual vehicles can be critical for appropriate autonomous vehicle behavior.

Third, embodiments of the technology can improve the quality of detections within world representations. By combining auditory flags with data from perception sensors, the system can generate enhanced emergency vehicle characterizations, including vehicle classification, movement patterns, and operational objectives. This multi-modal approach to perception can provide a more robust and complete understanding of emergency vehicle behavior compared to single-modality detection systems. For example, the integration of audio and visual data can help distinguish between different types of emergency vehicles (e.g., ambulance, fire truck, police vehicle) and their specific response patterns.

Fourth, embodiments of the technology can provide redundancy through distributed system architecture. The implementation of cloud-based components for sensor fusion, audio interpretation, tracking, and decision-making can enable continued system operation even when individual components experience failures or communication delays. The dual-path control architecture, incorporating both remote automatic decision-making and remote teleoperation capabilities, can provide multiple fallback options for vehicle control. This redundancy can be particularly valuable in situations where either local or remote automatic decision-making systems are compromised, or when teleoperation resources are temporarily unavailable.

However, variations of the technology can additionally or alternately provide any other suitable benefits and/or advantages.

### System

The system 100, an example of which is shown in FIG. 2, can include: a sensor suite, a computing system, and a vehicle control system. The system can optionally include a communication system, a remote computing system (e.g., remote tele-op system and/or redundant, remote computing system), and/or any other suitable components. However, the system 100 can additionally or alternatively include any other suitable set of components. The system functions to perform decision-making for an autonomous vehicle based on perceptual and audio measurements capturing information about an audio-emitting world agent.

The system can include or interface with a sensor suite (equivalently referred to herein as a sensor system) which functions to collect inputs for the computing system which can be used to determine control instructions for the autonomous agent, and/or can function to execute Block S100 and/or any other Blocks of the method. Additionally or alternatively, the sensor suite can function to enable the autonomous agent operations (e.g., autonomous driving, maneuvering the autonomous vehicle along a trajectory, etc.), data capture regarding the circumstances surrounding the autonomous agent, data capture relating to operations of the autonomous agent, detecting maintenance needs (e.g., through engine diagnostic sensors, exterior pressure sensor strips, sensor health sensors, etc.) of the autonomous agent, detecting cleanliness standards of autonomous agent interiors (e.g., internal cameras, ammonia sensors, methane sensors, alcohol vapor sensors), and/or perform any other suitable functions.

The sensor suite (equivalently referred to herein as a sensor system) can include vehicle sensors onboard the autonomous agent, such as any or all of: perception sensors, audio sensors, inertial sensors (e.g., accelerometers, gyroscopes, magnetometer, IMU, INS, etc.), external antennas (e.g., GPS, cellular, Bluetooth, Wi-Fi, Near Field Communication, etc.), diagnostic sensors (e.g., engine load, tire pressure, temperature sensors, etc.), vehicle movement sensors (e.g., inertial sensors, wheel-speed sensors, encoders, resolvers, etc.), environmental sensors (e.g., cameras, time-of-flight sensors, temperature sensors, wind speed/direction sensors, barometers, etc.), guidance sensors (e.g., LIDAR, Radar, infrared, cameras, etc.), computer vision (CV) sensors, cameras (e.g., stereocamera, hyperspectral, multi-spectral, video camera, wide-angle, CMOS, CCD, etc.), time-of-flight sensors (e.g., Radar, Lidar, sonar, etc.), and/or any other suitable sensors. The sensor suite preferably includes sensors onboard the autonomous vehicle (e.g., Radar sensors and/or Lidar sensors and/or cameras coupled to an exterior surface of the agent, IMUs and/or encoders coupled to and/or arranged within the agent, etc.), but can additionally or alternatively include sensors remote from the agent (e.g., as part of one or more infrastructure devices, sensors in communication with the agent, etc.), and/or any suitable sensors at any suitable locations. and/or any other suitable sensors.

However, the sensor suite can include any other suitable set of sensors, and/or can be otherwise suitably configured.

The sensor suite (a.k.a., sensor system) can include: audio sensors, perception sensors (a.k.a., perceptual sensor subsystem), and/or any other suitable sensors. Sensors of the sensor suite can be redundant and/or can include multiple sensors of each modality, but can alternatively include one sensor for a modality and/or can be otherwise configured. The sensors can be preferably statically mounted to the vehicle at different locations and/or different orientations, but can alternatively be otherwise mounted. The sensor system can be inside or outside the vehicle. The pose can be dynamic or fixed, actively-controlled or passively controlled, and/or otherwise controlled.

The perception sensors function to capture perceptual measurements about the physical space around the vehicle, motion of the vehicle, and/or state of vehicle components. The perception sensors can include cameras, LIDAR, Radar, ultrasonic sensors, IR cameras, and/or any other sensors. The perception sensors preferably include multiple sensors of each perception modality (e.g., cameras, LIDAR, and/or Radar), but can alternatively include a single perception sensor per modality. The perception sensors and/or each sensor thereof preferably has a known pose relative to other sensors and/or a vehicle reference frame (e.g., ego coordinate reference), and/or any other reference frame, but can alternatively not have a known pose. The perception sensors are preferably calibrated with sensors of same and/or different modality, but can alternatively not be calibrated, and/or can be otherwise configured.

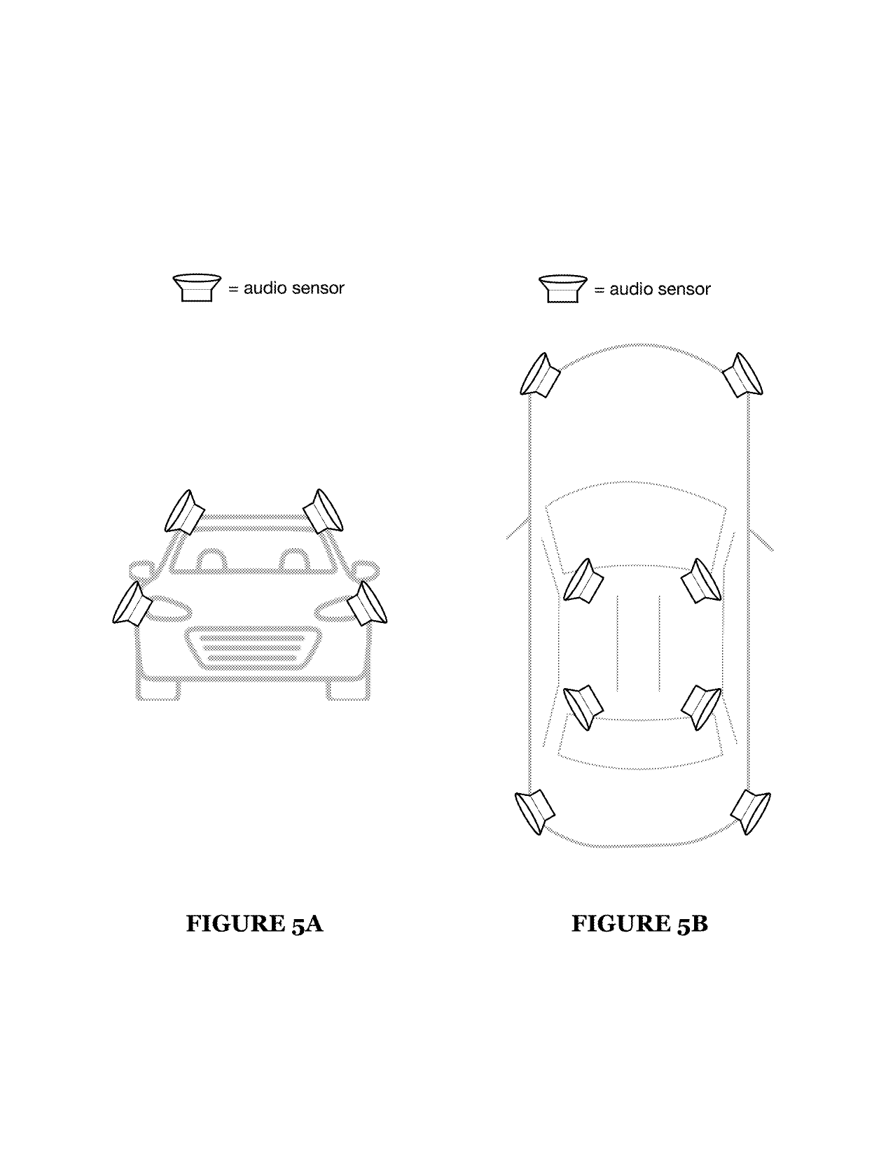

The audio sensor subsystem functions to capture audio measurements about world agents near the vehicle. The audio sensor subsystem preferably includes multiple audio sensors at different locations and/or in different orientations (e.g., example shown in FIG. 5A and FIG. 5B), but can additionally and/or alternatively include any other sensor configuration. Each sensor in the audio sensor subsystem can preferably be directed, but can alternatively be undirected and/or any other sensor type.

In some embodiments, the audio sensor subsystem can include a plurality of audio sensors arranged in a triangular configuration on an upper surface (e.g., roof-mounted) of the autonomous vehicle. The triangular configuration can include a first audio sensor positioned at or near a front-center region of the vehicle, a second audio sensor positioned at or near a left side of the vehicle, and a third audio sensor positioned at or near a right side of the vehicle. However, the audio sensors can alternatively be arranged in any other suitable spatial configuration (e.g., the four-sensor configuration shown in FIG. 5A and FIG. 5B, a linear array, a rectangular array, etc.).

The triangular arrangement of audio sensors can define a plurality of microphone pairs, including a front-left pair, a left-right pair, and a front-right pair. These microphone pairs can enable direction-of-arrival estimation through time-difference-of-arrival (TDOA) calculations, as described in further detail in connection with S300. The spatial separation between audio sensors in the triangular configuration is preferably sufficient to produce measurable time differences for audio signals arriving from different directions (e.g., a baseline distance of between approximately 0.5 meters and 3 meters between sensor pairs), but can alternatively have any other suitable spatial separation.

Each audio sensor in the subsystem is preferably a microphone capable of capturing audio signals at a sampling rate of at least 44.1 kHz, preferably 48 kHz, and can capture audio signals at any other suitable sampling rate. Each audio sensor preferably has a frequency response range encompassing frequencies characteristic of emergency vehicle sirens (e.g., approximately 500 Hz to 6000 Hz), but can have any other suitable frequency response range. Each audio sensor is preferably a digital MEMS microphone, but can alternatively be a condenser microphone, an electret microphone, a piezoelectric microphone, and/or any other suitable microphone type.

The audio sensor subsystem is preferably mounted in a manner that reduces mechanical vibration coupling from the vehicle (e.g., using vibration-isolating mounts, elastomeric bushings, etc.), but can alternatively be mounted without vibration isolation. Each audio sensor preferably includes a wind noise reduction mechanism (e.g., a foam windscreen, a perforated housing, etc.), but can alternatively not include wind noise reduction.

The audio sensor subsystem is preferably fixed in pose relative to the ego vehicle, but can alternatively include a rotating microphone and/or can be otherwise suitably configured. The pickup pattern(s) of the audio sensor subsystem can be: omnidirectional, cardioid, supercardioid, bidirectional, directional microphone (e.g., an interference tube microphone, line & gradient microphone, etc.), and/or can include any other pickup pattern(s).The audio sensor subsystem can include multiple audio sensors. In an example, a vehicle can include four audio sensors arranged in different directions relative to each other.

The audio sensor subsystem preferably has a known transform relative to each other and/or to the vehicle, but can additionally and/or alternatively be otherwise configured.

However, sensor system(s) and/or audio sensors thereof may be otherwise configured.

The computing system functions to perform operations on perceptual measurements, audio measurements, to extract information about the world and control the vehicle. Additionally or alternatively, the computing system can function to perform any or all of the processes involved in any or all of: perception, prediction, localization, planning, control, and/or any other processes involved in operation of the autonomous agent and/or execution of the method.

The computing system preferably includes an onboard computing system arranged onboard (e.g., integrated within) the autonomous agent. Additionally or alternatively, the computing system can include any or all of: a remote computing system (e.g., cloud computing system, remote computing in communication with an onboard computing system, in place of an onboard computing system, etc.), a computing system integrated in a supplementary device (e.g., mobile device, user device, etc.), an edge device including mobile computing devices, and/or any other suitable computing systems and devices. In some variations, for instance, the autonomous agent is operable in communication with a remote or disparate computing system that may include a user device (e.g., a mobile phone, a laptop, etc.), a remote server, a cloud server, or any other suitable local and/or distributed computing system remote from the vehicle. The remote computing system can be connected to one or more systems of the autonomous agent through one or more data connections (e.g., channels), but can alternatively communicate with the vehicle system in any suitable manner.

The computing system preferably includes a processing system (e.g., graphical processing unit or GPU, central processing unit or CPU, or any suitable processing circuitry) and memory, but can additionally or alternatively include any other suitable components. The memory can be short term (e.g., volatile, non-volatile, random access memory or RAM, etc.) and/or long term (e.g., flash memory, hard disk, etc.) memory.

In some variations, for instance, the onboard computing system functions to interact with and/or operably control any one or more of the identified components or modules described herein. In some embodiments, for instance, the onboard computing system executes computer instructions for implementing a multi-policy decisioning module (MPDM), which implements an MPDM process. In specific examples, the processing system and memory collectively function to dynamically manage the set of policies available to the autonomous agent in the framework of a multi-policy decision making framework, such as that described in U.S. Application serial number 16/514,624, filed 17-JUL-2019, and/or U.S. Application serial number 17/365,538, filed 01-JUL-2021, each of which is incorporated herein in its entirety by this reference. Additionally or alternatively, the processing system and memory, and/or any other suitable components, can be used for any other suitable functions.

In some embodiments, the computing system includes or interfaces with any or all of the perception system, the audio interpretation subsystem, the tracking subsystem, the decision-making subsystem, and the vehicle control subsystem, but can additionally and/or alternatively include or operate in conjunction with any other suitable subsystems. In some embodiments, the computing system preferably includes multiple computing subsystems with redundant capabilities. For example, the computing system can include a local computing subsystem on the autonomous vehicle, a remote computing subsystem in the cloud, and a teleoperation subsystem offboard the vehicle (e.g., cloud enabled, such as via WebRTC). The redundant computing subsystems can perform operations in parallel, but can alternatively have one serve as a backup for the other (e.g., performing operations only when one fails, needs verification, has latency with other system components, etc.). The redundant computing subsystems can perform the same operations, but can alternatively perform different operations. In an example, more sophisticated perception operations can be performed on the cloud than on the vehicle. In some embodiments, the computing system can include a local computing subsystem on the vehicle and a remote computing subsystem on the cloud. The computing system preferably performs all of S200-S600 on the local computing system, with the remote computing system serving as a backup for any or all steps or sub-steps. In some embodiments, the computing system can include multiple redundant local computing subsystems. The computing system can include a perception subsystem, an audio interpretation subsystem, a tracking subsystem, a decision-making subsystem, a vehicle control system, and/or any other suitable components.

The perception subsystem functions to determine a set of world representations based on perceptual measurements. For example, in some embodiments, the perception subsystem can be configured as described in U.S. Application Serial No. 19/092,856, which is incorporated herein by reference for all purposes, and/or can be otherwise configured. The perception subsystem preferably fuses perceptual measurements captured by perception sensors of the same and/or different modalities, but can additionally and/or alternatively be otherwise configured. The perception subsystem preferably runs on a local computing subsystem, but can alternatively run on a remote computing subsystem.

The world representation can refer to the ego vehicle’s understanding of its surroundings and the detection and/or characterization of world objects (e.g., static, dynamic, etc.; environmental representation) that occupy these surroundings. A world representation is preferably dynamically updated throughout the vehicle’s trip (e.g., periodically at a predetermined frequency), but can otherwise be suitably determined, updated, and/or maintained. In some embodiments, the world representation can include a location and classification (e.g., type such as “vehicle,” “pedestrian,” etc.) for each of a set of detected objects, and can optionally include additional information (e.g., state estimate, velocity, heading, orientation, size, etc.) for any or all objects. The set of world representations preferably includes a 1st world representation, where the 1st world representation can be produced with a trained learning process (e.g., with a set of trained machine learning models, with a set of deep learning models, etc.). The set of world representations can also preferably include a 2nd world representation which is preferably produced without trained models. The 1st and 2nd world representations are preferably produced in parallel, but can have any other relative temporal relationship. However, the perception subsystem can be otherwise configured to generate any other suitable world representation(s).

The audio interpretation subsystem functions to process audio measurements captured by audio sensors to generate auditory flags. The audio interpretation subsystem preferably performs S300 (determining a set of auditory flags), but can additionally and/or alternatively perform other functions. The audio interpretation subsystem can receive audio measurements from the audio sensors as inputs and can output auditory flags. In some embodiments, auditory flags can represent information about an audio emitting world agent (e.g., an ambulance, etc.), which can support low-confidence inferences made by the perception system and can improve perception accuracy (e.g., in S400, etc.). However, the computing system can include any other suitable audio interpretation subsystem(s).

The tracking subsystem functions to track the position of objects and/or agents represented within the world representation and/or represented by auditory flags over time. For example, in some embodiments, the tracking subsystem can be configured as described in U.S. Application Serial No. 19/091,533, which is incorporated herein by reference for all purposes, and/or can be otherwise configured. The tracking subsystem preferably performs S400 (tracking world agents), but can additionally and/or alternatively perform other functions. The tracking subsystem can receive inputs including world representation and auditory flags. The tracking subsystem can output different types of data. In some embodiments, the tracking subsystem can output a refined world representation. In some embodiments, the tracking subsystem can output object/agent tracks and/or any other tracking data. However, the computing system can include any other suitable tracking subsystem(s).

The decision-making subsystem functions to automatically determine vehicle actions and/or controls. The decision-making subsystem preferably performs S500 (determining vehicle controls), but can additionally and/or alternatively perform other functions. The decision-making subsystem can include or be used in conjunction with an MPDM system, but can alternatively be any other decision-making system. The decision-making subsystem can receive inputs including world representation(s), object/agent tracks, vehicle goals, and/or any other inputs. The decision-making subsystem can output: a policy election and/or control instructions derived therefrom (e.g., DBW commands), and/or any other outputs. However, the computing system can include any other suitable decision-making subsystem(s).

The vehicle control system functions to determine and/or execute control instructions at the vehicle. The vehicle control system is preferably a DBW system, but can additionally and/or alternatively be any other suitable vehicle control system.

However, the system can include any other suitable computing system(s) and/or computing elements, and/or the computing system can be otherwise configured.

The communication system functions to transmit data between a local computing subsystem and/or a remote computing subsystem. The communication system can be located on the autonomous vehicle, at the remote cloud, and/or at any other location. The communication system can be communicatively connected to the computing system (e.g., local computing subsystem and/or remote computing subsystem). The communication system can communicate measurements (e.g., audio measurements, perceptual measurements, etc.), system state information, the world representation(s), auditory flags, tracks, vehicle decisions (e.g., policies, etc.), vehicle controls, and/or any other suitable information. The communication system can transmit information between any of: S100, S200, S300, S400, S500, S600 in embodiments where successive steps are performed at different computing systems. The communication system can alternatively transmit information between steps always (e.g., as a backup in case of step failure). The communication system can include transmitter, receiver, and/or any other communication components.

However, the system can include any other suitable components.

### Method

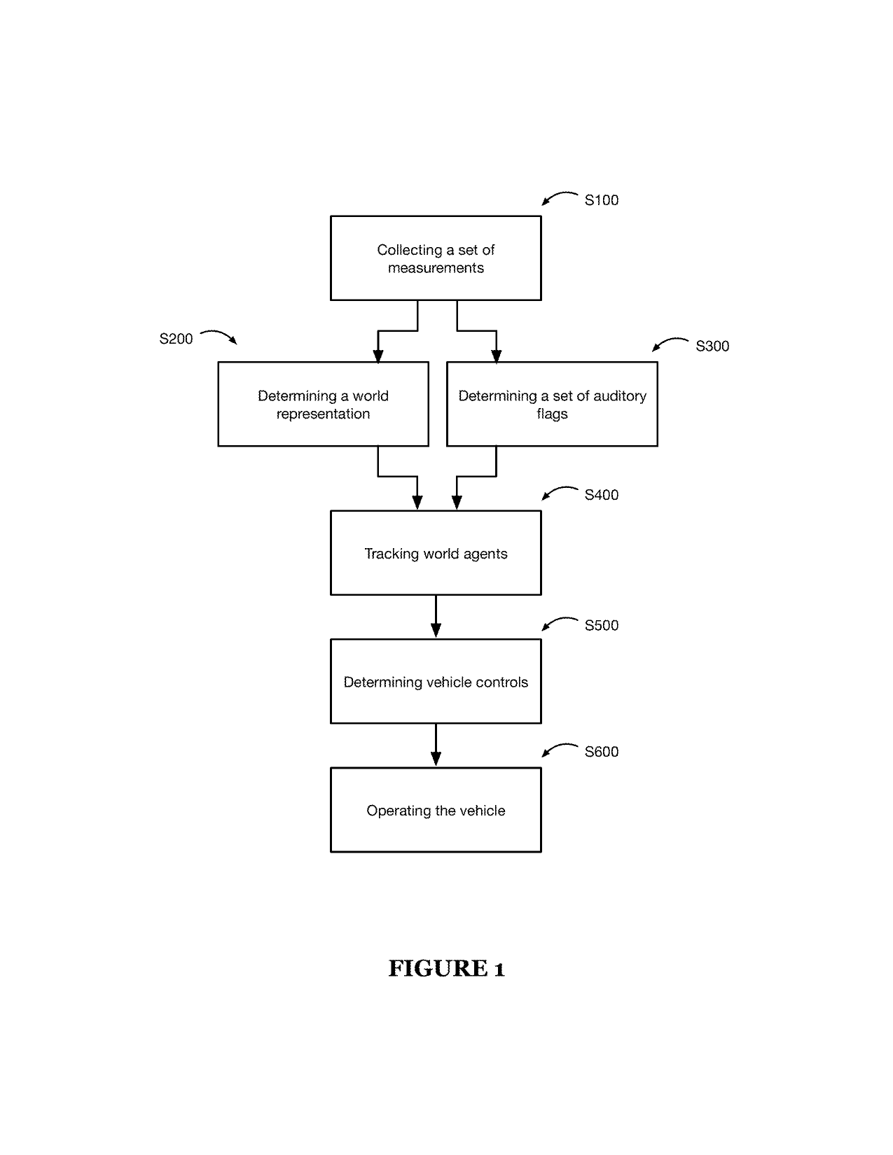

The method, an example of which is shown in FIG. 1, can include: collecting a set of measurements S100; determining a world representation S200; determining a set of auditory flags S300; tracking world agents S400; determining vehicle controls S500; controlling the vehicle S600; and/or any other suitable elements. However, the method can additionally or alternatively include any other suitable elements. The method functions to track an audio-emitting world agent based on both audio measurements and perceptual measurements (e.g., example shown in FIG. 1).

The method is preferably performed periodically and/or iteratively (e.g., making vehicle control decisions in real-time), but can alternatively be otherwise performed. The method can be performed during and/or in conjunction with autonomous vehicle control, but can additionally and/or alternatively be performed when the vehicle is being manually controlled (e.g., during teleoperation) or remotely assisted, and/or with any other suitable timing. The method is preferably cooperatively performed by system 100, but can be otherwise executed by any suitable system(s) onboard an autonomous vehicle, or remotely from the autonomous vehicle. For example, the method can be performed when a vehicle enters autonomy mode, when a vehicle detects an emergency vehicle (e.g., a siren), when a vehicle receives an alert that an emergency vehicle is nearby, and/or responsive to any other trigger condition(s). The method can optionally be performed in parallel on a local computing subsystem and a remote computing subsystem, but can alternatively not be performed in parallel. Outputs of each step (e.g., S200-S600) determined on one subsystem can be validated against outputs determined on the other computing subsystem, used for next steps performed on the other computing subsystem, and/or any other output usage. The system can switch between the local and remote computing systems performing steps of the method responsive to an error trigger (e.g., teleoperator non-responsiveness, latency, communicative disconnection between system components, a dangerous vehicle context, etc.). In some embodiments, a fallback condition for local automatic vehicle control can be where the cloud performs any/all of S200-S500 and sends information to the vehicle. In some embodiments, a fallback condition for local automatic vehicle control can be teleoperation performed using outputs from any/all of S100-S400 performed on the cloud and/or received from the local computing system. In an example, audio data can be interpreted on the cloud and the tracked auditory flags can be presented to the teleoperator via a UI. In some embodiments, a fallback condition for teleoperation (e.g., when the teleoperator is non-responsive or controlling the vehicle dangerously, etc.) can be remote and/or local automatic vehicle control.

### 4 1 Collecting a Set of Measurements S100

Collecting a set of measurements S100 functions to collect information about the world surrounding the autonomous vehicle. S100 is preferably performed iteratively (e.g., to capture measurements which enable real-time reaction and vehicle control), but can alternatively be otherwise performed. S100 can be performed by the sensor system and/or sensors thereof (e.g., the perceptual sensor subsystem and the audio sensor subsystem). S100 can include collecting a set of perceptual measurements using the perceptual sensor subsystem and collecting a set of audio measurements using the audio sensor subsystem. S100 preferably includes collecting audio measurements in parallel from different audio sensors at different poses on the autonomous vehicle, but can alternatively fuse various audio inputs into a unified data format and/or otherwise process audio data. S100 preferably includes associating the pose of each audio sensor with audio measurements captured by the audio sensor at the corresponding time, but can alternatively not include such association.

In an example, S100 can include collecting higher-quality (e.g., higher measurement capture frequency, higher definition, etc.) perceptual measurements for regions (e.g., directions, etc.) with a high probability of including an audio-emitting world agent of interest (e.g., an emergency vehicle) as determined from a tracked auditory flag from S310 in previous iterations of the method.

However, collecting a set of measurements S100 may be otherwise performed.

### 4 2 Determining a World Representation S200

Determining a world representation S200 functions to generate a virtual representation of the world based on perceptual measurements, which can be used by the tracking subsystem in S400 and the decision-making subsystem in S500. S200 preferably includes performing multimodal sensor fusion to synthesize perceptual measurements from different perceptual sensors and/or sensor modalities, but can additionally and/or alternatively be performed using any other determination method. S200 can optionally use auditory flags from previous/current iterations from S300 to improve confidence of detected agents within the world representation. In one embodiment, the world representation can include a set of tracks representing world agents, wherein the tracks are generated from matching detections of world agents observed through a time series of perceptual measurements into a unified environmental understanding. The perception subsystem can be configured as described in U.S. Application Serial No. 19/092,856, which is incorporated herein by reference, and/or can be otherwise configured.

### 4 2 1 Multimodal World Representation Architecture

In some embodiments, S200 includes producing a plurality of modality-specific world representations from the perceptual measurements, and fusing the plurality of modality-specific world representations to produce a fused world representation from which object detections are determined.

The modality-specific world representations preferably include: a 3D-derived world representation generated from 3D measurements (e.g., LiDAR point clouds); one or more camera world representations generated from camera measurements; one or more radar world representations generated from radar measurements; and optionally a map world representation generated from a priori map data (e.g., a route map, a road network map, etc.). Each modality-specific world representation is preferably generated in a common perspective (e.g., a bird’s eye view representation), but can alternatively be generated in different perspectives and transformed to a common perspective prior to fusion. However, the modality-specific world representations can include any other modalities and/or any other perspectives.

### 4 2 2 3D World Representation First World Representation

The 3D-derived world representation is preferably produced with a trained learning process and functions to provide a rich representation of the world with minimal noise and depth information derived from 3D sensor data. In some embodiments, the 3D-derived world representation is produced by: converting a set of 3D measurements (e.g., LiDAR point clouds) into a set of point pillars, wherein each point pillar represents a slice of the 3D measurement along a vertical axis and encodes z-height information into x,y positions; generating a multiscale representation of the environment from the point pillars (e.g., an octree, wherein each node of the octree recursively subdivides into smaller nodes based on point density); encoding the multiscale representation into a set of 3D-derived embeddings in a latent space (e.g., using transformer-based attention mechanisms applied to the octree structure); and decoding the 3D-derived embeddings into the 3D-derived world representation (e.g., a bird’s eye view frame, a set of cuboid detections, etc.). The 3D world representation architecture can be as described in U.S. Application Serial No. 19/092,856 and/or can be otherwise configured.

The 3D-derived world representation preferably includes a set of object detections, each comprising at least a position (e.g., represented as a bounding box or cuboid), a classification of an object (e.g., vehicle, pedestrian, bicycle, stationary object, etc.), and optionally additional state information (e.g., a learned encoding, a learned latent state vector, position, velocity, heading, orientation, size, etc.). Each object detection is preferably associated with a confidence score representing the likelihood that the detection corresponds to an actual object in the environment. These confidence scores can be used by the tracking subsystem in S400, where they can be increased or decreased based on association with auditory flags as described herein.

### 4 2 3 Classical World Representation Second World Representation

The second world representation is preferably produced without trained models (e.g., using classical, hand-engineered, rule-based, and/or heuristic methods) and functions to provide a supplemental representation of the environment that can detect objects potentially missed by the trained detection process. The second world representation is preferably produced in parallel with the first world representation.

In some embodiments, the second world representation is produced by: segmenting the 3D measurements (e.g., LiDAR point clouds) into foreground and background regions; clustering foreground points into discrete groups (e.g., using DBSCAN, hierarchical clustering, or other clustering methods); and generating hulls (e.g., volumetric representations, surface meshes) around each point cluster to represent detected objects. The second world representation can detect objects without necessarily classifying them, thereby providing a broader but potentially noisier set of object candidates compared to the first world representation. The classical world representation architecture can be as described in U.S. Application Serial No. 19/092,856 and/or can be otherwise configured.

The first world representation and the second world representation can correspond to the closed world representation and the open world representation, respectively, as described in U.S. Application Serial No. 19/091,533. The tracking subsystem can receive both world representations and evaluate detections from each alongside auditory flags from S300, as described in S400.

### 4 2 4 Sensor Fusion and Multimodal Embedding

S200 preferably includes fusing the plurality of modality-specific world representations into a fused world representation. In some embodiments, the fusion includes encoding the modality-specific world representations (e.g., the 3D-derived world representation, camera world representations, radar world representations, and optionally the map world representation) into a common multimodal latent space using a fusion module (e.g., a BEV fusion module comprising one or more encoding layers). The fusion module preferably produces a fused latent feature set (e.g., a multimodal latent embedding) that encodes information from all available sensor modalities in a unified representation. The fused latent feature set is preferably decoded into a final set of object detections using a decoding module (e.g., a detection head, a segmentation head, a set of deconvolutional layers, etc.).

In some embodiments, the multiple sets of detections are preferably produced through multiple (e.g., 2, 3, 4, etc.) different types of detection processes. In some embodiments, for instance, a first set of detections is produced with one or more trained models, and a second set of detections is produced with one or more classical (e.g., hand-engineered, rule-based, heuristics, etc.; non-learned/non-trained) algorithms. Additionally or alternatively, other processes can be used, additional processes can be used, multiple trained processes (e.g., each using a different model architecture) can be used, multiple classical algorithmic processes (e.g., each using a different algorithm) can be used, and/or the sets of detections can be otherwise suitably produced. The different processes can use: the same data, different data (e.g., partially overlapping, non-overlapping, etc.), and/or any other data or combinations of data. For example, in some embodiments, a larger set of sensor data (e.g., from all types of sensors on the vehicle, from all sensors on the vehicle, etc.) is used for a first process (e.g., trained model evaluation) than a set used for a second process (e.g., algorithmic process).

Pursuant to some embodiments, the fusion module is trained using dropout of input modalities during training, such that the fusion module can produce object detections even when one or more sensor modalities are unavailable or degraded (e.g., when LiDAR is noisy in rain, when cameras are obscured by glare, etc.). The multimodal sensor fusion architecture can be as described in U.S. Application Serial No. 19/092,856 and/or can be otherwise configured.

### 4 2 5 Temporal Fusion

S200 can optionally include temporal fusion of world representations across timesteps. In some embodiments, the fused latent feature set for the current timestep is stored in a memory buffer (e.g., a FIFO queue) alongside fused latent feature sets from prior timesteps. A memory fusion module encodes the current and prior fused latent feature sets into a temporally fused embedding in a temporal latent space. The temporally fused embedding can be combined with the current fused latent feature set and decoded into the final set of object detections. The temporal fusion architecture can be as described in U.S. Application Serial No. 19/092,856 and/or can be otherwise configured.

### 4 2 6 Integration of Auditory Flags with World Representation

S200 can optionally use auditory flags from S300 and/or S310 from previous and/or current iterations of the method to improve the world representation. In some embodiments, auditory flags can improve the confidence of detected agents within the world representation, as described in S400. In some embodiments, S200 can include performing more advanced perceptual measurement interpretation (e.g., devoting more computing resources, using a larger neural network, activating additional detector heads, increasing sensor resolution, etc.) for regions (e.g., directions, sectors of the environment, etc.) with a high probability of including an audio-emitting world agent of interest (e.g., an emergency vehicle) as indicated by a tracked auditory flag.

In some embodiments, S200 can include using auditory flags to estimate the number of audio-emitting world agents in a scene. For example, when the perception system detects a single emergency vehicle but auditory flags indicate two distinct siren sources (e.g., based on different siren frequency ranges, different directions of arrival, and/or different auditory track trajectories), S200 can include searching for a second emergency vehicle that may be partially or fully occluded by the first. This cross-modal cueing from the audio interpretation subsystem to the perception subsystem can enable detection of objects that would otherwise be missed by visual perception alone.

The integration of auditory flags with the world representation extends the principle of multimodal complementarity. Just as radar measurements can compensate for LiDAR limitations in adverse weather, and camera measurements can provide color and texture information unavailable from LiDAR, audio measurements can compensate for visual perception limitations caused by occlusion. An emergency vehicle that is audible but visually occluded (e.g., behind buildings, around a corner, in a traffic queue) can still be detected and tracked through auditory flags, providing the perception and tracking subsystems with advance information about the world agent before it becomes visually detectable.

However, determining a world representation S200 may be otherwise performed.

### 4 3 Determining a Set of Auditory Flags S300

Determining a set of auditory flags S300 functions to interpret audio measurements to infer information about audio-emitting world agents in the world. S300 is preferably performed by the audio interpretation subsystem, but can alternatively be performed by any other system component. S300 preferably uses sensor measurements captured by microphones with different orientations to estimate audio-emitting world agent direction, but can additionally and/or alternatively use any other measurements.

### 4 3 1 Audio Preprocessing

In some embodiments, S300 can include preprocessing audio measurements captured by each audio sensor of the audio sensor subsystem. The audio measurements are preferably captured at a sampling rate of 48 kHz, but can alternatively be captured at any other suitable sampling rate (e.g., 44.1 kHz, 96 kHz, etc.), and/or can be resampled to a uniform sampling rate if the audio sensors operate at different native sampling rates.

In some embodiments, S300 may include segmenting a continuous audio stream from each audio sensor into audio chunks of a predetermined duration. In some embodiments, each audio chunk has a duration of approximately 960 milliseconds, corresponding to approximately 46,080 samples at a 48 kHz sampling rate. However, the audio chunk duration can alternatively be any other suitable duration (e.g., between 500 milliseconds and 2000 milliseconds).

For each audio chunk, S300 may include computing a Short-Time Fourier Transform (STFT). The STFT is preferably computed using a window function (e.g., a Hann window) with a window length of approximately 25 milliseconds and a hop length (e.g., stride) of approximately 10 milliseconds, producing a time-frequency representation of the audio chunk. However, the STFT can alternatively be computed with any other suitable window length (e.g., between 10 milliseconds and 50 milliseconds), any other suitable hop length, and/or any other suitable window function.

The time-frequency representation produced by the STFT may further be transformed into a log-mel spectrogram. The mel-scale transformation preferably integrates the frequency bins of the STFT into a set of mel-spaced frequency bins. In some embodiments, the STFT output is integrated into 64 mel-spaced frequency bins, but the number of mel bins can alternatively be any other suitable number (e.g., 40, 80, 128, etc.). The magnitude of each mel-frequency bin is preferably log-transformed (e.g., by computing the logarithm of the magnitude after adding a small offset to avoid numerical issues with zero-valued bins) to produce the log-mel spectrogram. The resulting log-mel spectrogram serves as the input to a trained classification model.

### 4 3 2 Emergency Vehicle Classification Model

S300 may include processing the log-mel spectrogram with a trained classification model to determine auditory flag attributes. In some embodiments, the trained classification model is a two-dimensional convolutional neural network (2D CNN). The 2D CNN receives the log-mel spectrogram as a two-dimensional input (e.g., with dimensions corresponding to mel-frequency bins and time frames) and processes it through a series of convolutional layers, activation functions, and pooling operations to extract features relevant to emergency vehicle audio detection.

In some embodiments, the 2D CNN architecture can include: a first convolutional layer (e.g., with 32 filters and a 3×3 kernel) followed by a rectified linear unit (ReLU) activation and a max pooling operation; a second convolutional layer (e.g., with 64 filters and a 3×3 kernel) followed by a ReLU activation and a global average pooling operation; and a set of fully connected layers. However, the CNN architecture can alternatively include any other suitable number of convolutional layers, filter counts, kernel sizes, activation functions, pooling operations, and/or any other suitable architectural elements.

The 2D CNN may include a multi-head output architecture with a first output head and a second output head. The first output head (a classification head) preferably outputs a set of class predictions, including a siren status (e.g., a binary classification indicating presence or absence of an emergency vehicle siren) and a horn status (e.g., a binary classification indicating presence or absence of a vehicle horn). The second output head (a frequency regression head) preferably outputs a predicted siren frequency range, including a minimum siren frequency and a maximum siren frequency.

The inclusion of both the classification head and the frequency regression head in a single model enables a dual-purpose architecture: the classification head determines whether an emergency vehicle siren is present, while the frequency regression head simultaneously estimates the spectral characteristics of the detected siren. As described below, the predicted siren frequency range output by the frequency regression head can be used to generate a time-frequency mask for siren signal isolation, thereby enabling downstream direction-of-arrival estimation. This feedback from the classification stage into the localization stage represents an integrated detection-and-localization pipeline wherein the classification model’s spectral output directly informs spatial estimation.

### 4 3 3 Model Training

In some embodiments, the 2D CNN is trained on a training dataset comprising labeled audio samples. The training dataset can include audio samples from a plurality of sources, including: targeted audio data collected by on-vehicle microphones during real-world driving, audio data from public audio datasets (e.g., Google AudioSet, academic publications, etc.), and audio extracted from vehicle operation logs. The training labels for each audio sample preferably include a horn status, a siren status, and a siren frequency range (minimum and maximum frequency).

The training dataset may be augmented with a set of data augmentation transformations applied at random during training to improve model robustness. The augmentation transformations can include: Doppler shift simulation, amplification, attenuation, dynamic range compression, superposition of multiple siren signals, simulation of missed audio frames, and/or any other suitable augmentation transformations.

In some embodiments, the model is trained using a composite loss function that combines a classification loss and a regression loss. The classification loss is preferably a focal loss applied to the class predictions, which can address class imbalance by down-weighting well-classified examples. The regression loss may be a mean squared error (MSE) loss applied to the predicted siren frequency range. The composite loss may be a weighted sum of the classification loss and the regression loss.

### 4 3 4 On-Vehicle Detection Pipeline

In some embodiments, S300 is performed on the autonomous vehicle using a multi-threaded detection architecture. Each audio sensor of the audio sensor subsystem is preferably associated with a separate detector instance executing on a separate computational thread. Each detector instance may maintain an independent audio buffer for its corresponding audio sensor.

In some embodiments, audio frames received from each audio sensor are accumulated in the corresponding audio buffer until the buffer reaches a predetermined size (e.g., corresponding to the audio chunk duration of approximately 960 milliseconds). When the buffer reaches the predetermined size, a main detection buffer for that detector instance is updated with the accumulated audio data. This buffer management approach can regulate the inference rate and can reduce computational overhead by preventing frequent buffer update operations.

In some embodiments, inference using the trained classification model is run independently on each audio sensor’s detection buffer, producing per-microphone detection results. The per-microphone detection results are preferably fused to produce a consolidated emergency vehicle detection status. In some embodiments, the fusion includes determining that an emergency vehicle is detected if any audio sensor has produced a positive siren detection within a temporal fusion window (e.g., within the last 150 milliseconds). The temporal fusion window can function as a temporal filter to suppress transient false positives. However, the temporal fusion window can alternatively have any other suitable duration (e.g., between 50 milliseconds and 500 milliseconds), and/or the per-microphone fusion can use any other suitable fusion method.

### 4 3 5 Siren Signal Isolation and Direction-of-Arrival Estimation

When the consolidated emergency vehicle detection status indicates a positive siren detection, S300, in some embodiments, further includes estimating a direction of arrival (DoA) of the audio-emitting world agent. The DoA estimation may include a siren signal isolation step followed by a time-difference-of-arrival (TDOA) computation and geometric triangulation.

In some embodiments, the siren signal isolation step includes generating a time-frequency mask based on the siren frequency range predicted by the frequency regression head of the classification model. Specifically, the predicted minimum siren frequency and maximum siren frequency define a frequency band within the STFT representation. A time-frequency mask is generated that retains frequency components within the predicted siren frequency band and attenuates frequency components outside the band. This time-frequency mask is applied to the complex-valued STFT representations of the audio signals from each audio sensor, producing isolated siren signal representations for each audio sensor. By isolating the siren signal from background noise, traffic sounds, and other non-siren audio components prior to TDOA computation, the direction-of-arrival estimation accuracy can be improved relative to performing TDOA computation on unfiltered audio signals.

Pursuant to some embodiments, the TDOA computation is performed using Generalized Cross-Correlation with Phase Transform (GCC-PHAT) for each microphone pair in the audio sensor subsystem. For a triangular configuration with three audio sensors, the GCC-PHAT computation produces TDOA estimates for three microphone pairs: a front-left pair, a left-right pair, and a front-right pair. GCC-PHAT can provide robust time delay estimation in reverberant and noisy environments by normalizing the cross-power spectral density.

Pursuant to some embodiments, the TDOA estimates from the plurality of microphone pairs are triangulated using geometric triangulation to determine a direction of arrival of the siren signal in a two-dimensional plane relative to the autonomous vehicle. Given known spatial positions of the audio sensors on the vehicle and the computed time delays, the triangulation can resolve the direction of the audio source to a 360-degree estimate relative to the vehicle’s heading.

### 4 3 6 Distance Estimation

S300 can optionally further include estimating a distance of the audio-emitting world agent from the autonomous vehicle. Pursuant to some embodiments, the distance estimation is based on sound pressure level (SPL) measurements of the isolated siren signal at each audio sensor. In some embodiments, the distance estimation uses an inverse square law model based on known reference sound levels for emergency vehicle sirens. For example, emergency vehicle sirens in the United States are regulated to produce sound pressure levels of approximately 118–123 dB at a reference distance of approximately 3 meters. Because sound pressure level decreases by approximately 6 dB for each doubling of distance in a free-field environment, the measured SPL of the siren signal at the audio sensors can be compared to the known reference SPL to estimate the distance of the emergency vehicle.

### 4 3 7 Auditory Flag Structure

Based on the foregoing processing, each auditory flag generated in S300 may include at least: a siren status indicator (e.g., a binary indicator and/or a confidence score indicating the presence of an emergency vehicle siren); a horn status indicator; a predicted siren frequency range (e.g., minimum and maximum frequencies); a direction-of-arrival estimate (e.g., a bearing angle relative to the vehicle heading and/or a probability distribution over directions); and optionally a distance estimate. Each auditory flag may be associated with a timestamp corresponding to the audio chunk from which it was derived.

### 4 3 8 Tracking Auditory Flags S310

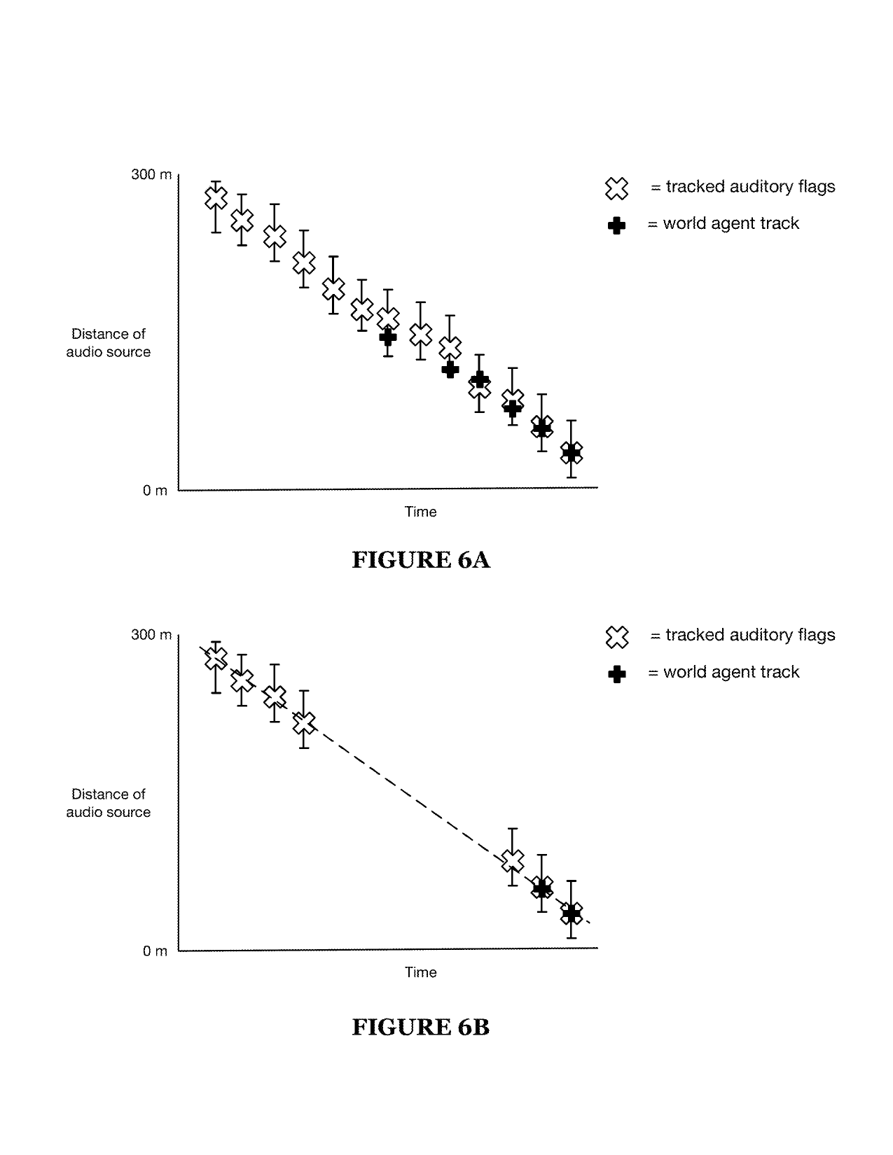

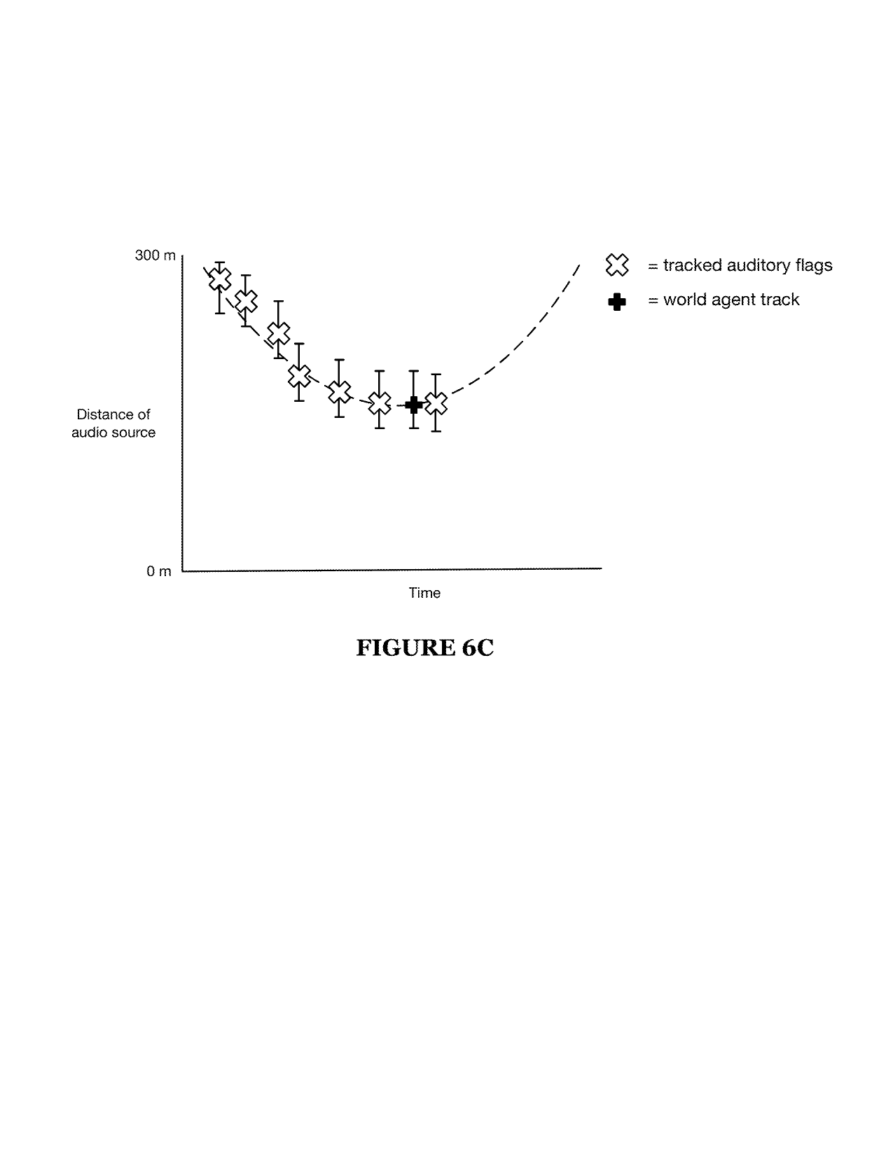

Tracking auditory flags S310 functions to determine a time series of auditory flags (e.g., represented as an auditory track) corresponding to an audio-emitting world agent. S310 can include matching each of a discontinuous or continuous time series of auditory flags (e.g., for an audio-emitting world agent which turns off a siren and turns it back on again at a different location; an example is shown in FIG. 6B). Examples of methods for tracking auditory flags over time can include probabilistic data association, multiple hypothesis tracking (MHT), feature-based association, sequential pattern matching, Kalman filtering, particle filtering, and/or any other suitable methods.

S310 can include fitting a trajectory curve to the auditory flags and can include predicting a future relative position of the audio-emitting world agent to the autonomous agent. In an example, S310 can predict that the audio-emitting world agent will not come closer to the autonomous vehicle based on a shape of the trajectory curve (e.g., example shown in FIG. 6C). S310 can include using/merging multiple auditory flags (e.g., over consecutive sampling intervals, etc.) to increase the confidence of each auditory flag and/or correcting auditory flags to conform to a fit trajectory curve. In some embodiments, S310 can track multiple auditory flags from different audio-emitting world agents at the same time.

However, determining a set of auditory flags S300 may be otherwise performed.

### 4 4 Tracking World Agents

Tracking world agents S400 functions to track the position, state, and existence of world agents over time based on a world representation determined in S200, a set of auditory flags determined in S300, and optionally a visibility representation. S400 is preferably performed by the tracking subsystem but can additionally and/or alternatively be performed by any other system. The tracking subsystem can be configured as described in U.S. Application Serial No. 19/091,533, which is incorporated herein by reference, and/or can be otherwise configured.

### 4 4 1 Observation Sources and Multi-Modal Tracking

In some embodiments, S400 includes receiving observations from a plurality of observation sources and evaluating the observations together within a unified tracking framework. The plurality of observation sources may include at least: a first set of observations determined from perceptual measurements using one or more trained detection processes (e.g., a closed world representation); a second set of observations determined from perceptual measurements using one or more non-trained detection processes (e.g., an open world representation); and a third set of observations derived from auditory flags determined in S300 (e.g., an auditory observation set).

The closed world representation and open world representation can be produced as described in U.S. Application Serial No. 19/091,533. The auditory observation set preferably includes auditory flags and/or auditory tracks determined in S300 and S310, wherein each auditory flag includes at least a direction-of-arrival estimate, and optionally a distance estimate, a siren classification, a horn classification, a siren frequency range, and/or any other attributes. The tracking subsystem can simultaneously consider and propagate observations from all three sources while performing the tracking process, which can confer benefits of increasing robustness and accuracy by leveraging complementary information across modalities.

### 4 4 2 Hypothesis Generation with Auditory Observations

In some embodiments, S400 includes generating a set of hypotheses representing possible correspondences between observations (including auditory observations) and existing tracks. The hypothesis generation framework is preferably performed as described in U.S. Application Serial No. 19/091,533, extended to include auditory observations as an additional observation source.

Hypotheses involving auditory observations can include any or all of: a hypothesis that an auditory flag corresponds to an existing track; a hypothesis that an auditory flag represents a new track; a hypothesis that an auditory flag does not correspond to any track; and/or any other hypotheses. In generating hypotheses for auditory observations, the likelihood that an auditory flag corresponds to a particular track can be determined based on spatial consistency, temporal consistency, classification consistency, and/or any other consistency measures.

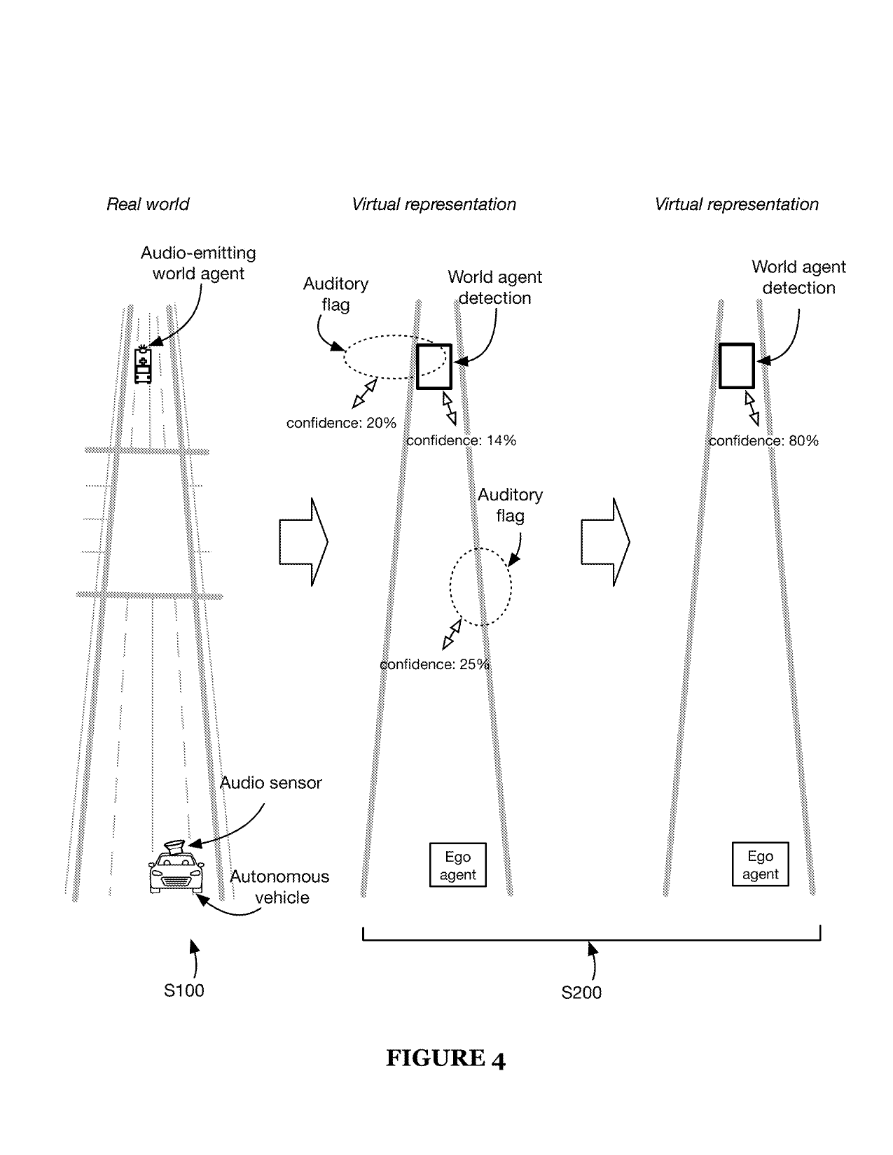

In some embodiments, S400 can include tracking world agents using auditory flags and/or auditory (flag) tracks. In a first example, when a world agent (e.g., an emergency vehicle) becomes visible (e.g., represented in perceptual measurements, etc.), it can be associated (e.g., fused) with historical auditory flags (e.g., an auditory track, etc.) near the estimated location of the world agent. Recent history of newly-observed agents can enable faster decision-making about agent behavior and more advanced warning about oncoming emergency vehicles (e.g., example shown in FIG. 6A). In a second example, the position of a tracked world agent can be refined based on the auditory flag direction and/or auditory flag distance from the autonomous vehicle. The confidence of a low confidence world agent detection can be increased based on its overlap with a tracked auditory flag (e.g., example shown in FIG. 4). In a third example, the path of the world agent can be determined based on estimated real-world positions of tracked auditory flags and/or a trajectory curve determined therefrom. In a specific example, auditory flags are generated during a first period of time when an audio-emitting world agent is not visible and fused with perceptual tracks (e.g., world agent tracks, etc.) when the audio-emitting world agent becomes visible, extending the time history related to the audio-emitting world agent.

S400 can include estimating speed, trajectory, distance/proximity, class, and/or any other suitable attribute(s) of a (tracked) world agent, which can be output as part of the world agent track(s). The world agent tracks can include a time series of references to the world agent between frames, a time series of inferences about the world agent (e.g., type, speed, etc.), and/or any other suitable information. The world agent tracks can be associated with inferences determined automatically from the time series (e.g., trajectory, speed, bearing, heading, etc.). In an example, the world agent tracks can include a curve fit to both world agent tracks and tracked auditory flags.

### 4 4 3 Visibility Representation and Probability of Detection

S400 can optionally include determining a visibility representation and using the visibility representation to estimate a probability of detection for each track. The visibility representation can be determined as described in U.S. Application Serial No. 19/091,533 (e.g., a 2D visibility map representing visibility of the ground plane from overhead, determined by ray casting from Lidar measurements, etc.).

In some embodiments, the probability of detection can be used in conjunction with auditory observations to improve tracking of audio-emitting world agents. When a tracked world agent is in a region with low probability of detection (e.g., the track is in an occluded region), the absence of a visual observation can be explained by the occlusion rather than by the non-existence of the world agent. An auditory flag corresponding to the track can serve as an alternative observation that counteracts the non-detection, maintaining or increasing the track’s probability of existence even when the world agent is not visually detected. This can be particularly valuable for emergency vehicle detection, where an emergency vehicle may be audible before it is visible.

### 4 4 4 Probability of Existence Updates with Auditory Observations

In some embodiments, S400 includes determining and dynamically updating a probability of existence for each track, as described in U.S. Application Serial No. 19/091,533. In some embodiments, the probability of existence update incorporates auditory observations as follows. When a track is both visually detected and associated with an auditory flag, the probability of existence can be increased by a magnitude that reflects the corroborating multi-modal evidence. When a track is not visually detected but is associated with an auditory flag, the probability of existence can be maintained at a level higher than it would be if no observation of any modality were present. The degree to which the auditory observation counteracts the non-visual-detection can depend on the probability of detection: in regions of low visual probability of detection (high occlusion), the auditory observation has a stronger effect on maintaining probability of existence.

The probability of existence can be determined using any suitable framework, including a Poisson Multi-Bernoulli Mixturing (PMBM) framework, Bayesian existence updates, log-likelihood ratio (LLR) scoring, delta-generalized labeled multi-Bernoulli (δ-GLMB), labeled multi-Bernoulli (LMB), Joint Integrated Probabilistic Data Association (JIPIDA), multi-hypothesis tracking (MHT), and/or any other suitable methods as described in U.S. Application Serial No. 19/091,533.

### 4 4 5 Auditory Flag Association with Perceptual Tracks

In some embodiments, S400 includes associating auditory flags and/or auditory tracks with perceptual tracks. In some embodiments, association is based on spatial proximity and directional consistency. In some embodiments, association is based on probabilistic data association. In still further embodiments, association is based on classification consistency. When an auditory flag is associated with a perceptual track, the confidence of the perceptual track can be increased (e.g., as illustrated in FIG. 4).

### 4 4 6 Audio-Only Tracks and Transition to Fused Tracks

When an auditory flag does not correspond to any existing perceptual track, S400 can include creating and maintaining an audio-only track. The audio-only track represents a world agent that is audible but not yet visible. When the audio-emitting world agent subsequently becomes visible, the audio-only track can be merged with the newly-appeared perceptual detection to create a fused track. The fused track inherits the historical auditory flags, thereby extending the effective tracking history of the world agent to include the period during which it was audible but not visible (e.g., as illustrated in FIG. 6A).

### 4 4 7 Track Output

Pursuant to some embodiments, the output of S400 includes a set of world agent tracks, where each track includes any or all of: kinematic data, temporal data, a probability of existence, a classification, an auditory status (e.g., whether the track is associated with an active auditory flag), an occlusion status, a bounding hull, and/or any other suitable information. The world agent tracks may be output to the decision-making subsystem for use in S500.

However, world agents can be otherwise tracked and/or S400 may be otherwise performed.

### 4 5 Determining Vehicle Controls S500

Determining vehicle controls S500 functions to make decisions about the vehicle trajectory. Pursuant to some embodiments, S500 is performed by the computing system and/or a decision-making subsystem thereof, but can alternatively be performed by another suitable system(s).

In some embodiments, S500 can be performed automatically by a decision-making subsystem onboard the vehicle. In some embodiments, S500 can be performed via teleoperator, where information about the current context can be displayed to the teleoperator via a teleoperation interface. In some embodiments, S500 can be performed by an in-vehicle operator.

In some embodiments, S500 can include executing a predetermined fallback instruction (e.g., “pull over”). In some embodiments, S500 can include implementing a policy associated with the identified type of audio source (e.g., “ambulance policy,” “police car policy”). The vehicle control policies can include a pull-over policy, a yield-at-intersection policy, a clear-lane policy, a stop-in-place policy, and/or any other suitable policies. The selection of a vehicle control policy can be based on at least one attribute of the tracked emergency vehicle, including direction of approach, distance, closing rate, emergency vehicle classification, and/or any other attributes.

S500 can be based on the measurements, world representation, auditory flags, auditory tracks, world agent tracks, and/or any other inputs. S500 can include determining an output command, such as a vehicle trajectory, path/waypoints, target location, and/or any other output(s). However, determining vehicle controls S500 may be otherwise performed.

### 4 6 Controlling the Vehicle S600

Controlling the vehicle S600 functions to convert a decision into executable commands for the autonomous vehicle. S600 preferably includes DBW commands, but can alternatively include commands of any other type. However, controlling the vehicle S600 may be otherwise performed.

Alternative embodiments implement the above methods and/or processing modules in non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

The following description of the preferred embodiments of the invention is not intended to limit the invention to these preferred embodiments, but rather to enable any person skilled in the art to make and use this invention.

We claim:

1. A method for operating an autonomous vehicle, the method comprising:
collecting, by a sensor system onboard the autonomous vehicle, a set of perceptual measurements using a perceptual sensor subsystem and a set of audio measurements using an audio sensor subsystem comprising a plurality of audio sensors arranged at different positions on the autonomous vehicle;
determining, by a computing system, a world representation based on the set of perceptual measurements, the world representation comprising a set of detections of world agents in an environment surrounding the autonomous vehicle;
determining, by the computing system, a set of auditory flags based on the set of audio measurements, each auditory flag comprising at least an estimate of a direction of an audio-emitting world agent relative to the autonomous vehicle;
tracking, by the computing system, a set of world agent tracks based on the world representation and the set of auditory flags, wherein tracking comprises associating at least one auditory flag with at least one detection of a world agent within the world representation;
determining, by the computing system, a set of vehicle controls based on the set of world agent tracks; and
operating the autonomous vehicle according to the set of vehicle controls.

2. The method of claim 1, wherein determining the set of auditory flags comprises:
computing a log-mel spectrogram from the set of audio measurements; and processing the log-mel spectrogram with a trained convolutional neural network to predict at least a siren status and a siren frequency range.

3. The method of claim 2, wherein the trained convolutional neural network comprises a multi-head output architecture including:
a classification head configured to output the siren status; and
a frequency regression head configured to output the siren frequency range, the siren frequency range comprising a predicted minimum siren frequency and a predicted maximum siren frequency.

4. The method of claim 2, wherein determining the set of auditory flags further comprises:
responsive to a positive siren detection, generating a time-frequency mask based on the predicted siren frequency range;
applying the time-frequency mask to a Short-Time Fourier Transform representation of the audio measurements from each audio sensor to produce an isolated siren signal representation for each audio sensor; and
computing the estimate of the direction of the audio-emitting world agent based on the isolated siren signal representations.

5. The method of claim 4, wherein computing the estimate of the direction comprises:
computing a time difference of arrival for each of a plurality of microphone pairs using Generalized Cross-Correlation with Phase Transform; and
triangulating the time differences of arrival across the plurality of microphone pairs to determine the direction of the audio-emitting world agent relative to the autonomous vehicle.

6. The method of claim 1, wherein each auditory flag further comprises an estimate of a distance of the audio-emitting world agent from the autonomous vehicle, the distance estimate determined based on a sound pressure level of a detected siren signal measured at the plurality of audio sensors and a known reference sound pressure level at a reference distance.

7. The method of claim 2, wherein the trained convolutional neural network further predicts a horn status, the horn status enabling the computing system to distinguish between a siren signal and a horn signal from the audio-emitting world agent, wherein predicting the horn status can include predicting the horn status of a siren signal and a horn signal from the same audio-emitting world agent.

8. The method of claim 1, wherein collecting the set of audio measurements comprises:
processing audio streams from each audio sensor of the plurality of audio sensors on a separate computational thread;
accumulating audio frames from each audio sensor in an independent audio buffer associated with that audio sensor; and
performing inference using a trained classification model independently on each audio buffer to produce per-microphone detection results.

9. The method of claim 8, further comprising:
fusing the per-microphone detection results to produce a consolidated emergency vehicle detection status, wherein the fusing comprises determining a positive emergency vehicle detection if at least one audio sensor produced a positive siren detection within a predetermined temporal fusion window.

10. The method of claim 9, wherein the predetermined temporal fusion window is between approximately 50 milliseconds and approximately 500 milliseconds.

11. The method of claim 1, wherein associating at least one auditory flag with at least one detection of a world agent comprises:
determining spatial consistency between the estimate of the direction of the audio-emitting world agent and a position of the detection of the world agent relative to the autonomous vehicle; and
responsive to determining spatial consistency, increasing a confidence score associated with the detection of the world agent within the world representation.

12. The method of claim 1, further comprising:
maintaining an audio-only track comprising a time series of auditory flags when the audio-emitting world agent is not represented in the world representation;
responsive to the audio-emitting world agent becoming represented in the world representation, associating the audio-only track with a detection of the audio-emitting world agent; and
merging the audio-only track with a perceptual track of the audio-emitting world agent to extend a tracking history of the audio-emitting world agent.

13. The method of claim 12, wherein the extended tracking history is used to estimate at least one of: a trajectory, a speed, a heading, or a closing rate of the audio-emitting world agent prior to the audio-emitting world agent becoming represented in the world representation.

14. The method of claim 1, further comprising:
tracking auditory flags over a time series to generate an auditory track corresponding to the audio-emitting world agent; and
fitting a trajectory curve to the auditory track to predict a future position of the audio-emitting world agent relative to the autonomous vehicle.

15. The method of claim 1, wherein determining the set of vehicle controls comprises:
identifying, from the set of world agent tracks, a tracked world agent classified as an emergency vehicle; and
selecting a vehicle control policy from a plurality of vehicle control policies based on at least one attribute of the tracked emergency vehicle, the at least one attribute including at least one of: a direction of approach relative to the autonomous vehicle, a distance from the autonomous vehicle, a closing rate, or a classification of the emergency vehicle.

16. The method of claim 15, wherein the plurality of vehicle control policies comprises at least one of: a pull-over policy, a yield-at-intersection policy, a clear-lane policy, or a stop-in-place policy.

17. The method of claim 15, wherein selecting the vehicle control policy is responsive to the tracked emergency vehicle satisfying a confidence threshold based on a combination of the auditory flag and the detection of the world agent within the world representation.

18. The method of claim 1, further comprising:
responsive to determining the set of auditory flags, collecting higher-quality perceptual measurements for a region corresponding to the estimate of the direction of the audio-emitting world agent, wherein higher-quality perceptual measurements comprise at least one of: a higher measurement capture frequency, a higher resolution, or perceptual measurements processed with greater computational resources.

19. The method of claim 1, wherein the world representation comprises a first world representation produced using a set of trained machine learning models and a second world representation produced without trained models, wherein the first world representation and the second world representation are produced in parallel.

20. The method of claim 1, wherein the plurality of audio sensors are arranged in a triangular configuration on an upper surface of the autonomous vehicle, the triangular configuration comprising a first audio sensor at a front-center region, a second audio sensor at a left side, and a third audio sensor at a right side of the autonomous vehicle, defining a front-left microphone pair, a left-right microphone pair, and a front-right microphone pair.

21. The method of claim 1, wherein the computing system comprises a local computing subsystem onboard the autonomous vehicle and a remote computing subsystem, and wherein determining the world representation, determining the set of auditory flags, tracking the set of world agent tracks, and determining the set of vehicle controls are performed on the local computing subsystem; and the remote computing subsystem is configured to perform the processing as a backup responsive to an error condition at the local computing subsystem.

22. The method of claim 21, further comprising:
responsive to an error condition at both the local computing subsystem and the remote computing subsystem, transmitting information derived from the processing on the local computing subsystem to a teleoperation interface for human decision-making.

23. A system for operating an autonomous vehicle, the system comprising:
a perceptual sensor subsystem configured to capture perceptual measurements of an environment surrounding the autonomous vehicle;
an audio sensor subsystem comprising a plurality of audio sensors arranged at different positions on the autonomous vehicle, each audio sensor configured to capture audio measurements;
a computing system configured to:
determine a world representation based on the perceptual measurements, the world representation comprising a set of detections of world agents;
determine a set of auditory flags based on the audio measurements, each auditory flag comprising at least an estimate of a direction of an audio-emitting world agent relative to the autonomous vehicle;
track a set of world agent tracks by associating at least one auditory flag with at least one detection of a world agent within the world representation; and
determine a set of vehicle controls based on the set of world agent tracks; and
a vehicle control system configured to operate the autonomous vehicle according to the set of vehicle controls.
